(19) United States
(12) Patent Application Publication
(10) Pub. No.: US 2020/0077096 A1
(43) Pub. Date: Mar. 5, 2020

(54) Compression of segmented video

(71) Applicants: Jonatan Samuelsson, Stockholm (SE); Per Hermansson, Stockholm (SE)

(72) Inventors: Jonatan Samuelsson, Stockholm (SE); Per Hermansson, Stockholm (SE)

(21) Appl. No.: 16/118,508

(22) Filed: Aug. 31, 2018

(51) Int. Cl. H04N 19/159; H04N 19/105; H04N 19/132; H04N 19/172

(52) U.S. Cl. CPC H04N 19/159; H04N 19/172; H04N 19/132; H04N 19/105

(57) ABSTRACT

The present invention relates to an encoder (600), a decoder (500) and methods for efficient compression of segmented video. Efficient compression is achieved through the usage of open-GOP intra pictures and through storing coded pictures in a bitstream (100) in an order which is different from the coding order. A decoder (500) can decode the bitstream (100) by determining for at least one coded picture (10) that the coded picture (10) should be buffered, and then buffering that coded picture (10) until another coded picture (20) has been decoded, and then decoding the first coded picture (10) using that other coded picture (20) as a reference picture.

### TECHNICAL FIELD

The embodiments generally relate to encoding/decoding pictures of segmented video.

### BACKGROUND

Digital video consists of a sequence of pictures of a certain resolution (i.e. width and height) in which each picture is represented by one (monochrome) or multiple color components. Color components typically represent Red, Green, Blue (RGB) or some form of luma/chroma representation (e.g. YCbCr) which can be called YUV where Y represents luma, luminance, or intensity and U and V represent the different chroma components. Each picture consists of a two-dimensional array of samples for each color component. The size of the array, can be the same for all color components (called 4:4:4 sampling) or lower in resolution for the chroma components. One common example of this is called 4:2:0 sampling in which the width and the height of both chroma components are half of the width and the height of the luma component. Each sample is typically represented by a value of fixed bit-length, which is called the bitdepth of the sample, for example 8, 10, or 12, indicating the magnitude of that color component at that position of the picture. Combined, these properties of a video sequence (resolution, chroma sampling, bit-depth etc.) defines the video format.

A picture can be converted from one video format to another video format in a process called resampling. Resampling may involve processing, such as different types of filtering or dithering.

Digital video can be stored and transmitted in uncompressed form, but it is more common to apply some form of compression to the video, in order to reduce the size of the video. During the compression process, which is also called encoding, a bitstream is created. The encoding of a picture of a video stream can either be performed based on an uncompressed picture or on a picture that already has been compressed. In either case it can be said that an encoder encodes a coded picture since the result of the encoding will be a coded picture. A bitstream consist of a representation of one or more coded pictures. A decoder decompresses the bitstream in a process called decoding in order to generate output pictures that can be displayed to a user. There exist several standards defining bitstream formats and decoding processes for compressed video. Among the most popular ones are MPEG-2 Part 2, MPEG-4 Part 10 (also known as AVC and H.264), and MPEG-H Part 2 (also known as HEVC and H.265). All of these standards share the same basic principle for compression which consists of that blocks of samples are predicted from earlier coded samples, and a representation of the difference between the prediction and the original sample values is coded. Prediction can be performed within the same picture, called intra prediction. A picture which only uses intra prediction is called and intra picture. Alternatively, prediction can be performed using one or more previously coded pictures, which is called inter prediction and a picture that is used for prediction is called a reference picture. The prediction is performed on blocks of samples and a picture which uses a mixture of intra prediction blocks (zero or more) and inter prediction blocks (one or more) is called an inter picture.

A specific type of intra prediction is the constrained intra prediction. Blocks encoded with constrained intra prediction are only allowed to predict from other blocks coded using constrained intra prediction. This ensures that the constrained intra predicted blocks will not be affected by potential problems that may exist in the reference picture(s), for example due to loss of data. In other words, the constrained intra predicted blocks do not predict, directly or indirectly, from blocks coded with inter prediction.

Video compression can either be lossless (in which case the exact values of the uncompressed video can be retained after decoding) or lossy (in which case information is lost during compression). For lossy video compression the goal is typically to make the encoded stream as small as possible while keeping the quality of the decoded video as high as possible. This goal is achieved by using as efficient compression methods as possible.

The pictures of a video sequence do not need to be encoded/decoded in the same order as they are output (displayed). The coding order represent the order in which pictures are encoded and decoded. Encoding and decoding needs to be performed in the same order since the pictures need to have the same reference pictures available. The output order represents the order in which pictures are output from the decoder and this will generally be the same order as the pictures are displayed in, and the same order as the original video sequence was originally captured or produced in. The purpose of using a different coding order compared to the output order is to be able to improve the prediction. A scheme called bi-prediction makes it possible for a picture to perform a weighted inter prediction from two different reference pictures. It would also be possible to perform weighted prediction from even more reference pictures but this is not common practice. The ability to use bi-prediction can significantly reduce the bitrate of an encoded stream without reducing the visual quality. A video encoder encodes the pictures into a bitstream in the coding order and a video decoder decodes the pictures according to the order in which they are coded in the bitstream, i.e. the coding order. When coding order differs from output order it can be said that reordering has been applied.

HEVC is the most advance video coding standard to date and it contains for example indications in the bitstream for performing tune-in (or random access) into a bitstream at a specific picture, which is an intra picture but not the first picture in the video. The random access indication can be seen as a promise that the picture at the random access point and all pictures that follow it in output order will be correctly decodable.

Random access points consists of an intra picture which can either be represented as an open-GOP intra picture or a closed-GOP intra picture, where GOP stands for Group Of Pictures. Open-GOP intra picture means that pictures that precedes the intra picture in output order are allowed to predict from the intra picture. An example of an open-GOP intra picture is shown in FIG. 1. where the pictures B2, B3 and B4 predicts, directly or indirectly from the open-GOP intra picture. In order to predict from the open-GOP intra picture, the pictures B2, B3 and B4 needs to follow the open-GOP intra picture in coding order. Closed-GOP intra picture means that pictures that precede the intra picture in output order are not allowed to predict, directly or indirectly, from the closed-GOP intra picture, at least not if they also predict from any picture that preceded the closed-GOP intra picture in coding order. An example of a closed-GOP intra picture is shown in FIG. 2. where the pictures B2, B3 and B4 are not allowed to predict, directly or indirectly from the closed-GOP intra picture. An open-GOP intra picture offers more efficient compression since it allows for pictures that preceded the intra picture in output order to apply bi-prediction using the intra picture as one of the reference pictures. For closed-GOP intra pictures, the pictures that preceded the intra picture in output order are not allowed to apply bi-prediction using both the intra picture and pictures that preceded the intra picture in coding order as reference pictures.

Pictures that precedes a random-access intra picture in output order but follow it in coding order can be called tail pictures. In the example in FIG. 1. the pictures B2, B3 and B4 are tail pictures.

In Adaptive Bit Rate (ABR) streaming scenarios, the same video sequence is encoded in multiple different versions, called representations, each with different bitrate and typically with different resolutions. The representations are then made available at a server together with a manifest file describing the properties of the different representations. By having multiple different representations of the same video available, a client can select which representation to download, decode, and display, based on the available bandwidth from the server to the client. In order to adaptively adjust to the network conditions, the representations are typically segmented into segments (typically between 1 and 12 seconds long) so that the client can switch from one representation to another. The segments are different consecutive pieces of a bitstream that, when concatenated, results in the full original bitstream. In practice, it is most common to let the different segments reside in the same file and provide to the client information about which byte ranges of that file corresponds to which segments. Switching means that the client stops fetching segments from one representation and instead starts fetching segment from a different representation. Switching is performed at so called switching points where the representations have intra pictures to allow for tuning-in (performing random access) to the representations. The last segment that was fetched before the switching point can be called the old segment and the first segment fetched after the switching point can be called the new segment.

In ABR streaming scenarios it is currently not feasible to use open-GOP intra pictures for the random access points. This is because when the client switches between different representations it will not have access to old reference pictures from the previous segment in the representation it switches to. If there are tail pictures that follows the intra picture in coding order and uses reference pictures preceding the intra picture in coding order then these will not be correctly decodable since some of the reference pictures they are supposed to predict from will not be available to the decoder. If those tail pictures are not decoded, there will be a gap in the sequence of pictures to be displayed resulting in an annoying glitch for the viewer.

A possible approach to address the problem of unavailable reference pictures is for the client to use reference pictures from a different representation as reference, possibly by resampling them to match the resolution of the representation in question. With this approach it would be possible to decode one representation of each picture as along as it is possible to find reference pictures that matches the ones required by the representation in question.

One problem with this approach is that the decoded pictures will look different depending on from which representation the switch is performed and it would be very difficult for an encoder to keep track of, and ensure that all possible switching operations will look acceptable. The problem of using incorrect reference data might be visible in all parts of the pictures but it is likely that it will be most visible, and most annoying, in intra coded blocks. This is due to the nature of the intra prediction, which may accentuate errors when predicting from erroneous data. Depending on the structure of the reference pictures (and the number of reference pictures used for prediction) it might be necessary to keep and resample multiple different reference pictures from the representation the client is switching from.

Another problem with this approach is that it requires all representations to use matching coding structure when it comes to reordering and reference pictures. In the example shown in FIG. 8, the first bitstream has a larger amount of reordering than the second bitstream. In the first bitstream there are 7 tail pictures and in the second bitstream there are only 3 tail pictures. If a client switches from the first bitstream to the second bitstream at the random access point, it will not receive any coded pictures for the time instances with output order number 1, 2, 3 and 4. This could result in an annoying glitch in the playout where the four pictures are missing.

Another possible approach to address the problem with open-GOP intra pictures for ABR streaming is that the client would fetch data from multiple representations when performing the switch and decoding both in parallel. By doing this, the decoder can ensure that all pictures are correctly decoded but the problem with this approach is that the decoder will be fetching more data than what is required, i.e. it will be a waste of bandwidth which reduces the video quality in the client and increase the risk for stall due to rebuffering. Stall due to rebuffering is when the playout of the video needs to be paused due to that there is not enough data available in the client to continue the playout.

For closed-GOP intra pictures, non of these problems occur since the segmentation of the bitstream can be performed so that each segment contains a consecutive sequence of pictures in both coding order and output order. For open-GOP intra pictures a segmentation of the bitstream will result in segments that contain consecutive sequences of pictures in coding order but not in output order. However, it would be desirable to be able to make efficient use of open-GOP intra pictures also for ABR streaming, since open-GOP intra pictures provides better compression efficiency than closed-GOP intra pictures.

### SUMMARY

The present invention solves the problems associated with open-GOP intra pictures for ABR streaming by storing coded pictures in a bitstream in an order Which is different from the coding order. The coding order is determined by the decoder using additional information encoded in the bitstream.

The order in which encoded pictures reside in the bitstream can be called network order. By allowing the network order to be different from coding order it is possible to let pictures that follow an intra picture in coding order, reside before the intra picture in network order. By doing this, it is possible to perform a segmentation such that each segment contains a set of pictures that are consecutive in output order (and network order) but not in coding order.

When the network order is different from the coding order, the decoder needs to restore the coding order so that the decoding of the pictures can be performed correctly, with the correct reference pictures available. Thus the decoder needs to derive how to change the order of the coded pictures by using information associated with the coded pictures. This could be performed based on some high level information or using some scheme determined independently of the bitstream. However, providing some form of indication along with the coded pictures constitutes a robust and flexible approach for how the decoder should determine the coding order. One way of indicating the coding order in the bitstream is to associate each coded picture with a value representing the coding order. This value could for example be encoded in the bitstream as an absolute value or as a difference value. The value could be for example be encoded using a fixed length field, using a variable length field or using some form of arithmetic coding. The value could be encoded using wrap-around (e.g. by applying a modulo operation) or using continuously increasing numbers.

Another scheme for indicating the coding order in the bitstream is to encode a flag with each picture to indicate if that picture should be decoded after any picture following the picture in network order. The flag could then be set (e.g. equal to one) for all pictures that follow a random-access intra picture in coding order but precedes it in output order. The intra picture itself would not have the flag set (i.e. it would be equal to 0) causing the decoder to buffer all pictures with the flag set until the intra picture has been received and decoded and then decoding the buffered pictures directly after the intra picture has been decoded.

When the bitstream is segmented into segments that are consecutive in output order it is possible to switch between different segments without introducing a glitch regardless of the coding structure of the different segments. The only picture that needs to be resampled is the intra picture from the representation the client is switching to.

If the intra picture from the segment the client is switching to is resampled and used for prediction, it will result in incorrect decoding with the risk of visually noticeable artifacts. If completely correct decoding is desired, the client can fetch the intra picture from both the segment it is switching from and the segment it is switching to. By decoding both of these intra pictures it is possible to get correctly decoded pictures both before the intra picture and after the intra picture.

As noted above, visual problems in the video can occur when the client switches without fetching overlapping ranges of data. This is because the intra picture used for decoding will not be the same as the one used for encoding, and so called drift would occur. However, it is possible to account for the drift and try to minimize the visibility of it by performing adjustments in the encoding process. One type of adjustment is to not use intra blocks in pictures that predict from open-GOP intra pictures. Another type of adjustment is to use constrained intra prediction instead of regular intra prediction in pictures that predict from an open-GOP intra picture. This has dual benefit; the problem of accentuated error (due to intra block predicting from erroneous data) is removed and the blocks that are coded with constrained intra will not have any errors at all since they do not use prediction (directly or indirectly) from any other picture.

An advantage of the embodiments of the present invention is that they make it possible to use open-GOP intra pictures in segmented video and thereby improves video quality, reduces bandwidth requirements and provides an enhanced user experience.

### BRIEF DESCRIPTION OF THE DRAWINGS

FIG. 1. illustrates a coding structure with an open-GOP intra picture.

FIG. 2. illustrates a coding structure with a closed-GOP intra picture.

FIG. 3. illustrates a schematic flow chart of a method of decoding according to embodiments of the present invention.

FIG. 4. illustrates a schematic flow chart of a method of encoding according to embodiments of the present invention.

FIG. 5. illustrates schematically an encoder and a decoder according to embodiments of the present invention.

FIG. 6. illustrates schematically reference structure and output order of coded pictures in two bitstreams according to embodiments of the present invention.

FIG. 7. illustrates schematically a reference structure and output order of coded pictures in two bitstreams where two pictures representing the same time instance are decoded.

FIG. 8. illustrates schematically a reference structure and output order of coded pictures in two bitstreams where the reference structure is not identical in the two bitstreams.

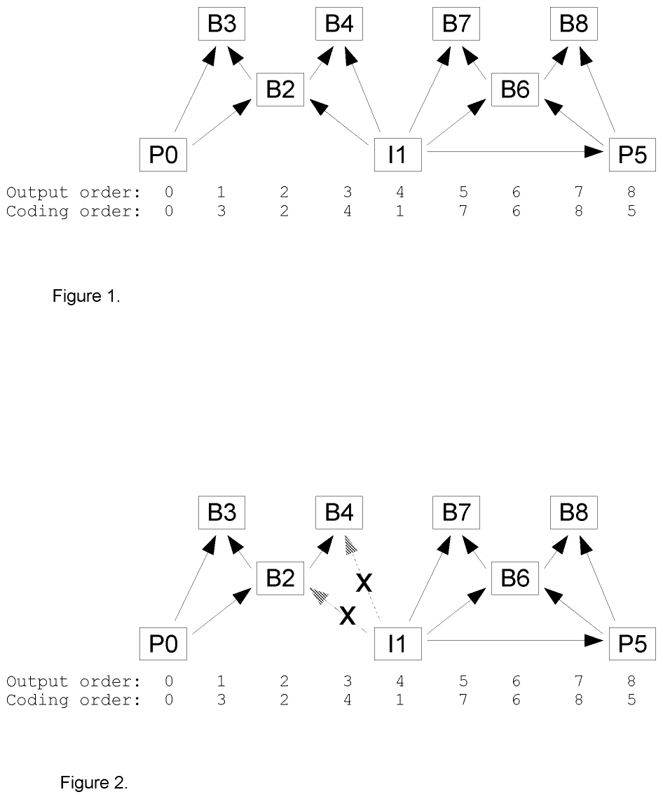

### DETAILED DESCRIPTION

As stated above, the object of the present invention is to enable efficient compression of segmented video by enabling efficient handling of open-GOP intra pictures for segmented video.

Efficient handling of open-GOP intra pictures is enabled through changing the order in which coded pictures reside in the bitstream compared to their coding order. By placing tail pictures before their associated random-access intra picture, a segmentation can be performed wherein each segment contains a consecutive set of pictures in output order, even when reordering has been applied during encoding. When the segmentation is performed so that tail pictures are contained in the old segment and the random-access intra picture is contained in the new segment, it is possible to concatenate segments from two different bitstreams and have a decodable sequence of coded pictures without glitches. The only picture that needs to be resampled is the random-access intra picture, in order for it to be used as reference picture of the tail pictures in the old segment.

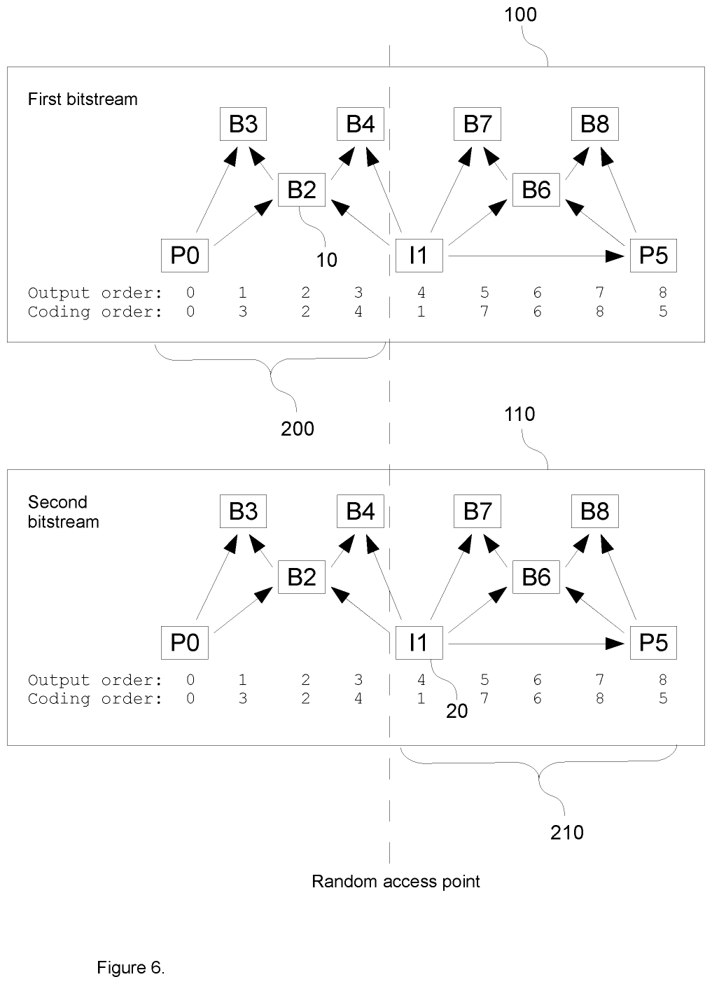

An example of the present invention is depicted in FIG. 6. where the first bitstream (100) contains a first segment (200) with four coded pictures. One of these four pictures is called the first coded picture (10). FIG. 6. also depicts a second bitstream (110) containing a second segment (210) with five coded pictures. One of these five pictures is the random-access intra picture, called the second coded picture (20). It can be seen from the reference structures, indicated by the arrows in the figure, that open-GOP intra coding has been used. The encoder that creates the bitstreams will according to the invention place the first coded picture (10) before the random-access intra picture in the bitstream. According to one embodiment of the present invention the encoder will encode, together with the first coded picture, an indication that the picture should be buffered by the decoder. The dotted line in FIG. 6 represents a random-access point indicating that a client that fetches segments for this video sequence may switch from fetching segments from one representation, to fetching segments from a different representation. The segments are delivered to the client's video decoder. It is said that the client accesses the coded pictures of the segments in order to decode them. Access can in this context represent for example receiving the coded pictures through some form of network connection, typically an IP connection. Access can also represent reading from some form of temporary or permanent storage, such as from a memory component of a device.

If the client performs a switching operation at the random-access point depicted in FIG. 6, it will fetch a first segment (200) from the first bitstream (100) and a second segment (210) from a second bitstream (110). The decoder will access the coded pictures in the same order as they reside in the bitstream. The first segment (200) from the first bitstream (100) will be delivered to the decoder before the second segment (210) from the second bitstream. The decoder will first access the first coded picture (10) which resides in the first segment (100) and then access the second coded picture (20) which resides in the second segment (210). According to the present invention, the decoder will determine that the first coded picture (10) should be buffered. In one embodiment of the present invention the determination step includes decoding and interpreting a binary value provided together with the first coded picture (10), where one binary value, e.g. equal to 1, represents that the coded picture should be buffered, and the other binary value, e.g. 0, represents that the picture should not be buffered. In the example in FIG. 6. the indication, if present, would indicate that the first coded picture should be buffered.

Buffered means in the context of the present invention that the picture should be maintained (e.g. stored) in compressed (coded) form by the decoder until some other event has occurred. More specifically, in the present invention, the decoder will maintain the first coded picture (10) in compressed form until the second coded picture (20) has been decoded.

When a decoder has determined that the first coded picture (10) should be buffered, it will be buffered. The decoder will then decode the second coded picture (20) and after the second coded picture (20) has been decoded, the first coded picture (10) will be decoded, using the second coded picture (20) as a reference picture. This means that the decoded sample values, and potentially other information, from the second coded picture (20) will be used to decode the first coded picture (10) for example through inter prediction.

It should be noted that more than one coded picture may be buffered before the decoding of a random-access intra picture. In the example in FIG. 6. the three pictures marked with B2, B3 and B4 will all be buffered to be decoded after the intra picture marked I1 has been decoded.

In one embodiment of the present invention, the decoder will perform a resampling operation of the sample values from the second coded picture (20) before using it as a reference picture when decoding the first coded picture (10). This can for example be performed if the resolution of the video in the first segment (200) is different from the resolution of the video in the second segment (210).

In one embodiment of the present invention, the decoder will determine that the second coded picture (20) should not be buffered based on information associated with the second coded picture.

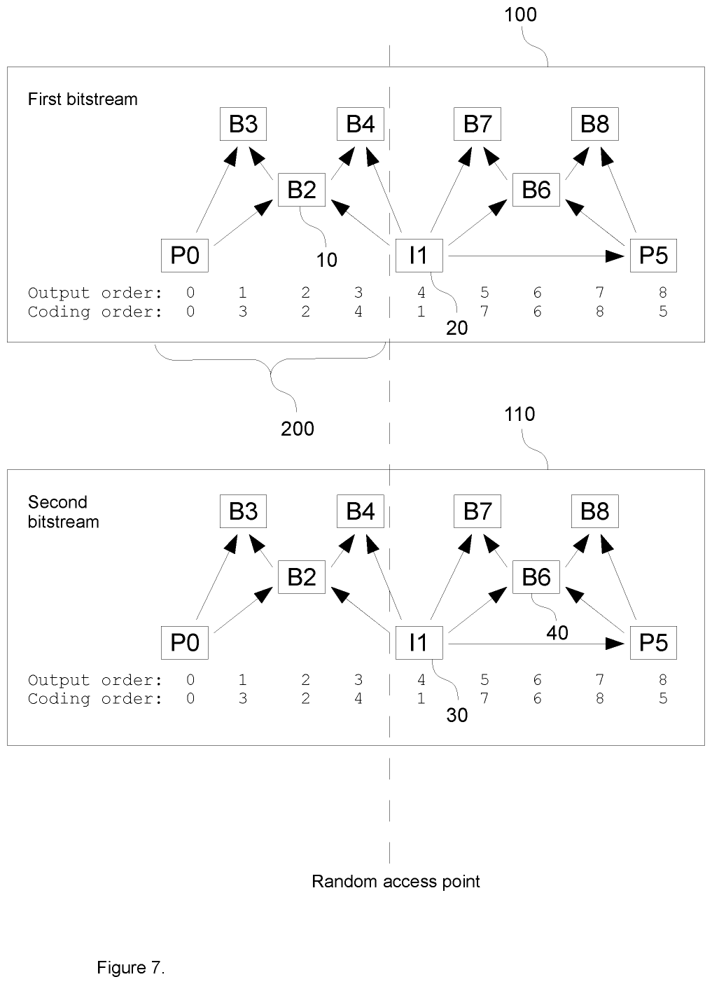

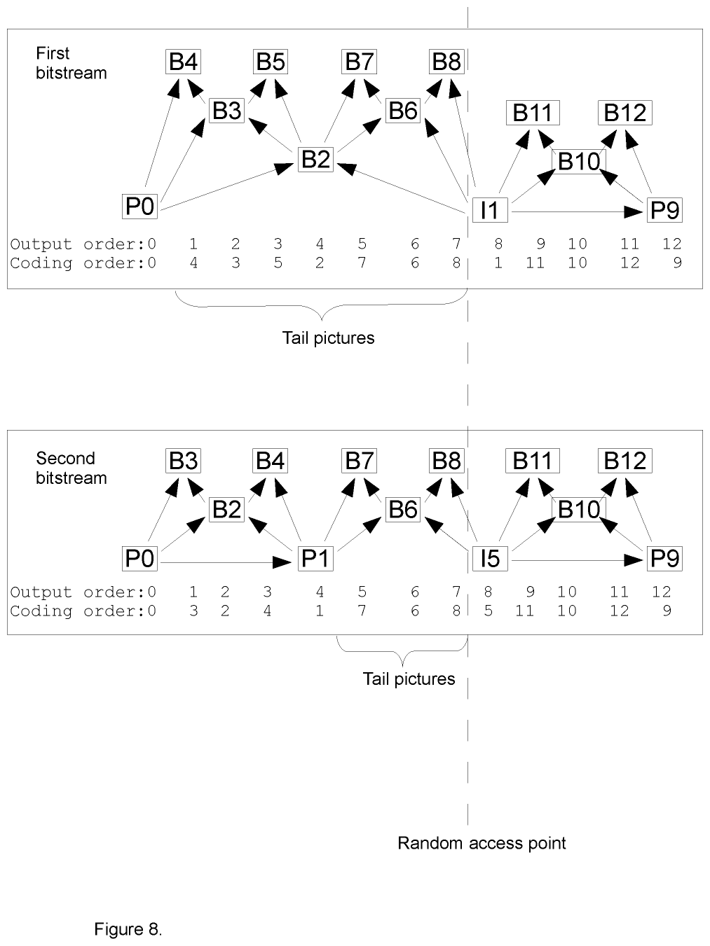

Another example of the present invention is depicted in FIG. 7. where the first bitstream (100) contains a first segment (200) with four coded pictures. In the example in FIG. 7. the decoder fetches not only the first segment (200) of the first bitstream (100) but also the random-access intra picture (20) from the first bitstream (100). This makes it possible for the decoder to decode the first coded picture (10) completely without errors or drift and without having to resample the random-access intra picture from the second bitstream (110). The random-access intra picture from the second bitstream is called a third coded picture (30), and it is decoded independently of the first coded picture (10) and the second coded picture (20), typically after these have been decoded. Only one of the second coded picture (20) and the third coded picture will typically be output/displayed and it is preferable to output/display the one with the highest quality. The third coded picture (30) will be used as reference picture when decoding a fourth coded picture (40) following the third coded picture (30) in output order.

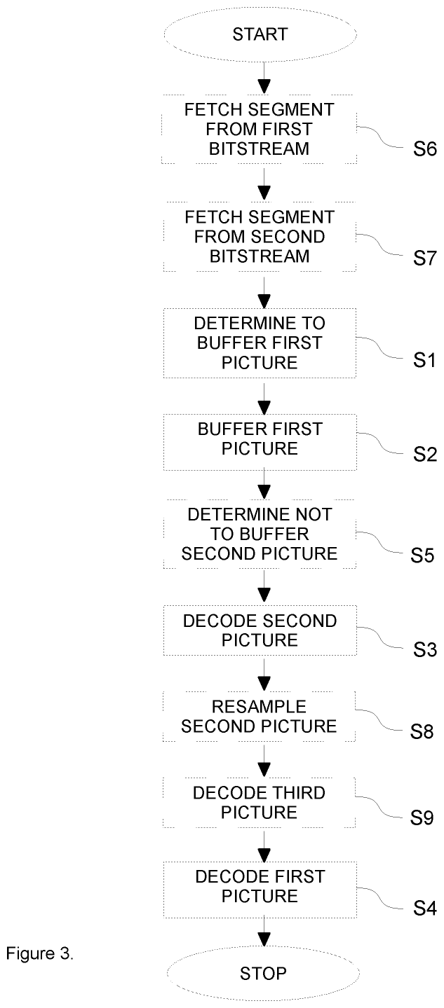

The flowchart in FIG. 3. illustrates the decoding steps according to the present invention where the steps within dashed lines represent optional steps that are performed only in some embodiments. The depicted order of the steps represents a natural processing order but it should be understood that some of the steps may be performed in a different order or in parallel.

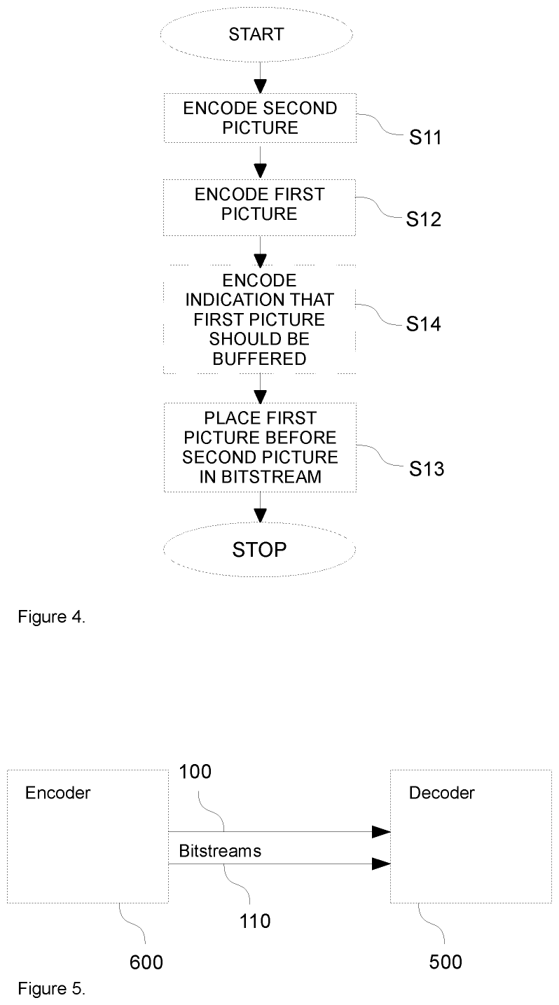

In a similar fashion, the flowchart in FIG. 4. illustrates the encoding steps according to the present invention where the steps within dashed lines represent optional steps that are performed only in some embodiments. The depicted order of the steps represents a natural processing order but it should be understood that some of the steps may be performed in a different order or in parallel.

FIG. 5. shows an example of an encoder (600) creating encoded bitstreams that are accessed by the decoder (600) according to the present invention. The encoder may be a hardware implementation of a video encoder, such as in a chip or a field programmable gate array. Alternatively, it may be a software implementation executed on a processing unit such as a central processing unit. Likewise, the decoder may be a hardware implementation of a video decoder, such as in a chip or a field programmable gate array. Alternatively, the decoder may be a software implementation executed on a processing unit such as a central processing unit. Encoders and/or decoders may be present in a large number of platforms and devices, including, but not limited to, mobile phones, tablets, laptop computers, stationary computers, servers, data centers, camcorders, head-mounted displays, television sets, set-top-boxes, video projectors and media players.

1. A method for decoding coded pictures of a video sequence consisting of at least a first segment (200) and a second segment (210), concatenated from a first bitstream (100) and a second bitstream (110) comprising the steps of:
determining (S1) based on coded information associated with a first coded picture (10), from the first segment (200) from the first bitstream (100), that the first coded picture (10) should be buffered by the decoder, and,
buffering (S2) the first coded picture (10), and,
decoding (S3) a second coded picture (20), from the second segment (210) from the second bitstream (110), and,
decoding (S4) the first coded picture (10), using the second coded picture (20) as a reference picture,
wherein the first coded picture (10) is accessed before the second coded picture (20) is accessed.

2. The method according to claim 1, wherein determining (S1) comprises parsing a binary parameter coded in the header information of the first coded picture (10), wherein one binary value represents that the first coded picture (10) should be buffered and the other binary value represents that the first coded picture (10) should not be buffered.

3. The method according to any of claims 1-2 further comprising the step of:
determining (S5) based on coded information associated with the second coded picture (20) that the second coded picture (20) should not be buffered by the decoder.

4. The method according to any of claims 1-3, wherein the first coded picture (10) resides in a first bitstream (100) and the second coded picture (20) resides in a second bitstream (110), the method further comprising the step of:
fetching (S6) a first segment (200) from the first bitstream (100) that includes the first coded picture (10), and,
fetching (S7) a second segment (210) from the second bitstream (110) that includes the second coded picture (10), and,
concatenating (S7b), the first segment (200) with the second segment (210).

5. The method according to any of claims 1-4 further comprising the step of:
resampling (S8) the second coded picture before performing the decoding (S4) of the first coded picture (10) using the second coded picture (20) as a reference picture.

6. The method according to any of claims 1-3 further comprising the step of:
decoding (S9) a third coded picture (30), wherein the third coded picture (30) represents the same time instance as the second coded picture (20) and wherein the third coded picture (30) is used as reference picture for decoding a fourth coded picture (40) following the third coded picture (30) in output order.

7. A method for encoding pictures of a video sequence comprising the steps of:
encoding (S11) a second coded picture (20) representing a random access point in a first bitstream (100), and,
encoding (S12) a first coded picture (10) preceding the second coded picture (20) in output order and following the second coded picture (20) in coding order, using the second coded picture (20) as a reference picture, and,
placing (S13) the first coded picture (10) before the second coded picture (20) in the first bitstream (100) so as to enable that a first segment (200) that includes the first coded picture (10) but not the second coded picture (20) from the first bitstream (100) can be concatenated with a second segment (210) from a second bitstream (110) and decoded.

8. The method according to claim 7, further comprising the step of:
encoding (S14) together with the first coded picture (10) an indication that the first coded picture (10) should be buffered by the decoder to be decoded after the second coded picture (10) has been decoded.

9. The method according to any of claims 7-8, wherein the encoding (S12) of the first coded picture (10) comprises encoding blocks of samples using inter or intra prediction and wherein the blocks coded with intra prediction do not predict, directly or indirectly, from blocks coded with inter prediction.

10. A decoder (500) configured to decode pictures of a video sequence consisting of coded segments, concatenated from a first bitstream (100) and a second bitstream (110) wherein the decoder (500) is configured to determine based on coded information associated with a first coded picture (10), originating from the first bitstream (100), that the first coded picture (10) should be buffered by the decoder (500), and wherein the decoder (500) is configured to buffer the first coded picture (10), and wherein the decoder (500) is configured to decode a second coded picture (20), originating from the second bitstream (110), and wherein the decoder (500) is configured to decode the first coded picture (10), using the second coded picture (20) as a reference picture (10).

11. An encoder (600) configured to encode pictures of a video sequence wherein the encoder (600) is configured to encode a second picture (20) representing a random access point in a first bitstream (100), and wherein the encoder (600) is configured to encode a first picture (10) preceding the second picture (20) in output order and following the second picture (20) in coding order, using the second picture (20) as a reference picture, and wherein the encoder (600) is configured to place the encoded representation of the first picture (10) before the encoded representation of the second picture (20) in the first coded bitstream (100) so as to enable that a first segment (200) that includes the first coded picture (10) but not the second coded picture (20) from the first bitstream (100) can be concatenated with a second segment (210) from a second bitstream (110) and decoded.
